(19) United States
(12) Patent Application Publication
(10) Pub. No.: US 2026/0146691 A1
(43) Pub. Date: May 28, 2026

(54) PIPE, PIPE CONNECTION AND PIPELINE SYSTEM

(71) Applicant: CORE LINEPIPE INC., Calgary (CA)

(72) Inventors: Wei-en CHEN, Calgary (CA); Gregory Michael HENRY, Calgary (CA); Samuel Glen BOUEY, Calgary (CA)

(21) Appl. No.: 19/397,301

(22) Filed: Nov. 21, 2025

Related U.S. Application Data
(60) Provisional application No. 63/724,128, filed on Nov. 22, 2024.

(51) Int. Cl. F16L 21/02; F16L 21/035

(52) U.S. Cl. CPC F16L 21/022; F16L 21/035

(57) ABSTRACT

A pipeline system includes a mechanical metal to metal connection that can provide a fluid tight seal. A pipe mandrel is employed to span the connection between bell ends on two pipes. The system includes at least one of: a) an elastomeric seal in an annular gland at an end of the mandrel; b) a stop ring encircling the mandrel and positioned between the belled ends; and c) wherein the teeth each have a radiused tip.

### CROSS REFERENCE TO RELATED APPLICATION

This application claims the benefit of U.S. provisional Application No. 63/724,128 entitled “Pipe, Pipe Connection and Pipeline System” filed Nov. 22, 2024, the technical disclosure of which is incorporated herein by reference in its entirety.

### FIELD OF THE INVENTION

The present invention relates to a pipeline system for conveying fluids and, in particular, to a pipe connection assembly, equipment and methods.

### BACKGROUND OF THE INVENTION

Pipelines are needed for conveying fluids such as water, oil effluent, natural gas, carbon dioxide or mining slurries some of which may be pressurized.

Thin walled metal pipes offer an advantage in terms of facilitated handling and reduced material costs for construction of pipelines. However, thin walled pipes have proven difficult to connect in a reliable and efficient manner.

Applicant introduced a pipeline system and method that has proven to be an excellent solution for connection of pipes, as described in U.S. Pat. Nos. 9,857,003 and 10,544,889. Continued research has led to improvements even to applicant's current technology.

### SUMMARY OF THE INVENTION

A pipeline system is provided for conveying fluids, including a pipe connection assembly, a pipe connection and a method.

In accordance with one aspect of the present invention, there is provided a pipe connection assembly comprising: a first pipe section and a second pipe section, each of the first pipe section and the second pipe section including: a metal tube having a length, an inner surface defining an inner diameter, an outer surface with an outer diameter, a wall thickness defined by the distance between the inner surface and the outer surface and a belled end with a larger inner diameter than the inner diameter through an adjacent portion of the metal tube and a larger outer diameter than the outer diameter; a pipe mandrel for mechanically engaging the first pipe section to the second pipe section, the pipe mandrel formed as a cylindrical tube and including a first tubular end configured to mechanically engage the first pipe section and a second tubular end configured to mechanically engage the second pipe section, the pipe mandrel being sized to be positionable within the belled ends of the first pipe section and the second pipe section, the pipe mandrel including teeth radially outwardly extending therefrom and having an inside diameter substantially equal to or greater than the inner diameter; a press ring having an inside diameter smaller than the outer diameter of the metal tube and the press ring configured to be installed encircling the belled end radially outwardly of the pipe mandrel and to deform and hold the belled end radially inwardly into engagement with the teeth; and at least one of: a) an elastomeric seal in an annular gland at each end of the mandrel; and b) a stop ring encircling the mandrel and positioned between the belled ends.

In accordance with another aspect of the present invention, there is provided a method for joining a first pipe section to a second pipe section, each of the first pipe section and the second pipe section including: a metal tube having a length, an inner surface defining an inner diameter, an outer surface with an outer diameter, a wall thickness defined by the distance between the inner surface and the outer surface and a belled end with a larger inner diameter than the inner diameter through an adjacent portion of the metal tube and a larger outer diameter than the outer diameter; the method comprising: inserting a pipe mandrel into the belled end of the first pipe section and into the belled end of the second pipe section; installing a press ring to encircle the belled end of the first pipe section, the press ring having an inner diameter smaller than a diameter across the outer surface of the belled end and installing the press ring includes deforming the metal tubular wall of the first pipe section radially inwardly into mechanical engagement with teeth on an outer diameter of the pipe mandrel; and leaving the press ring in place encircling the wall of the first pipe section to hold the wall in mechanical engagement with the pipe mandrel, wherein the method further comprises one or more of: inserting the pipe mandrel includes urging an annular elastomeric seal on an end of the pipe mandrel into sealing engagement against the inner diameter of the belled end; and positioning a stop ring around the pipe mandrel prior to inserting such that the stop ring resides between the belled ends and stopping advancement of the press ring during installing by abutting against the stop ring.

In accordance with yet another broad aspect, there is provided a pipe connection comprising: a first pipe having a length, an inner surface defining an inner diameter, an outer surface with an outer diameter, and a wall thickness defined by the distance between the inner surface and the outer surface; a second pipe having a cylindrical wall with a cylindrical outer surface and a cylindrical inner bore; a pipe mandrel mechanically engaging the first pipe to the second pipe, the pipe mandrel formed as a cylindrical tube with outwardly extending teeth and including a first tubular end mechanically engaged within the inner diameter and a second tubular end mechanically engaged within the cylindrical inner bore; a first press ring having an inside diameter smaller than the outer diameter of the first pipe, the press ring encircling the first pipe radially outwardly of the pipe mandrel and deforming the first pipe radially inwardly into engagement with the teeth on the first tubular end; a second press ring having a diameter smaller than the cylindrical outer surface of the second pipe, the second press ring encircling the second pipe radially outwardly of the pipe mandrel and deforming the second pipe radially inwardly into engagement with the teeth on the second tubular end; and at least one of: a) an elastomeric seal in an annular gland at each end of the mandrel; b) a stop ring encircling the mandrel and positioned between the belled ends; and c) wherein the teeth each have a radiused tip.

### BRIEF DESCRIPTION OF THE FIGURES

Referring to the figures wherein like reference numerals indicate similar parts throughout the several views, several aspects of the present invention are illustrated by way of example, and not by way of limitation, in detail in the figures, wherein:

FIG. 1A is sectional view through a pipe-to-pipe connection showing the ends of two discrete lengths of pipe and a mandrel for joining the pipes.

FIG. 1B is a perspective, exploded view of the pipe connection of FIG. 1A with the parts aligned along axis x ready for assembly.

FIGS. 2A and 2B are sectional views along long axis x showing a process to make up a pipe connection.

FIG. 3 is an enlarged sectional view of the end of a mandrel within a pipe.

FIG. 4 is an enlarged sectional view illustrating the engagement of a mandrel to a pipe.

### DETAILED DESCRIPTION

The detailed description set forth below in connection with the appended drawings is intended as a description of various embodiments of the present invention and is not intended to represent the only embodiments contemplated by the inventor. The detailed description includes specific details for the purpose of providing a comprehensive understanding of the present invention. However, it will be apparent to those skilled in the art that the present invention may be practiced without these specific details.

Applicant's technology described U.S. Pat. Nos. 9,857,003 and 10,544,889 included embodiments applicable to lined pipe and some embodiments applicable to both unlined pipe and plastic lined pipe.

The ease and reliability of connecting pipes have led to further research to expand the use of the fundamental technology in unlined pipe systems. Unlined pipes are particularly susceptible to corrosion issues, since the pipeline-conveyed fluids are in contact with the metal inner diameter of the pipe and the interior exposed parts of the pipe-to-pipe connection.

The present pipe connection assembly and method are configured to accomplish one or more of: a) to mitigate corrosion issues around the connection; b) to facilitate assembly; and c) to enhance the strength of the pipe-to-pipe connection.

### General

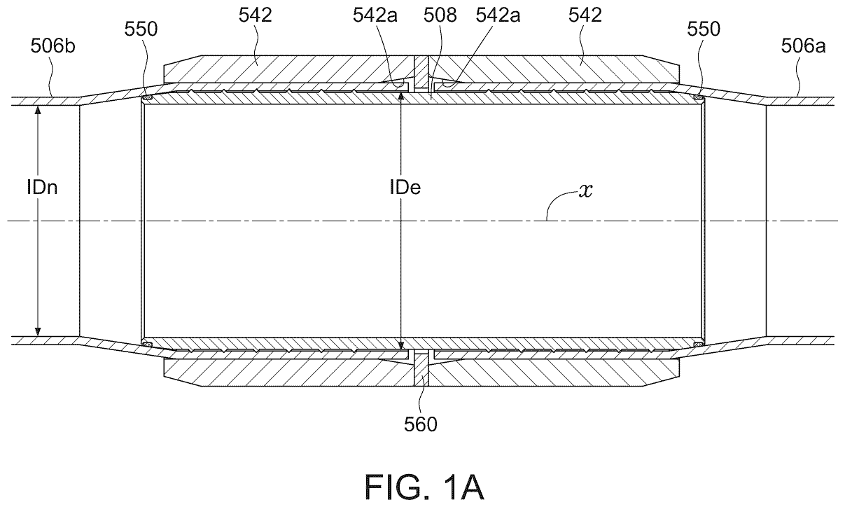

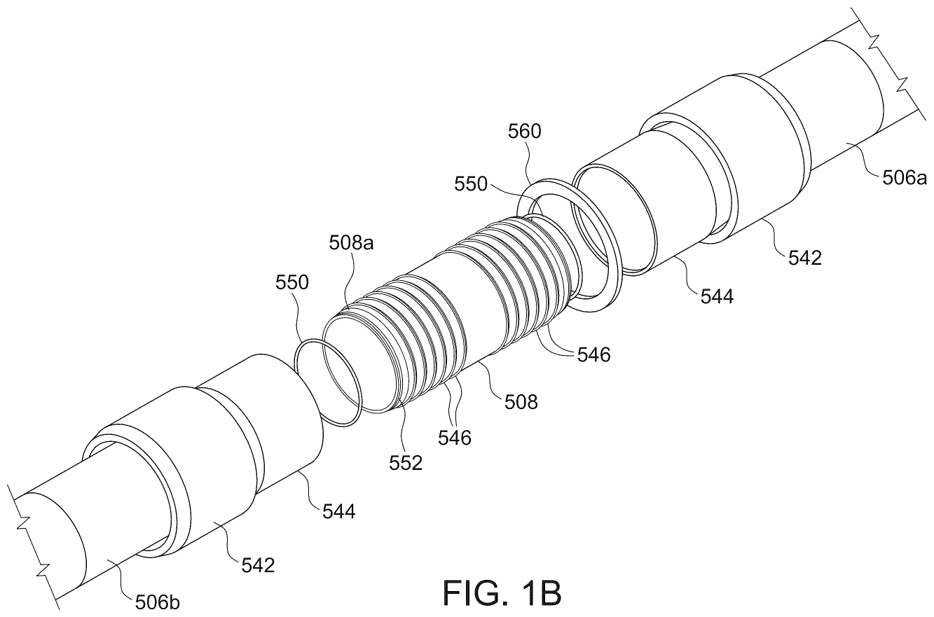

FIGS. 1A and 1B show the new pipe connection for use with at least unlined pipe. The illustrated pipe connection includes a mandrel 508 and press rings 542 for forming a metal-to-metal joint between two sections of pipe 506a, 506b. Pipes 506a, 506b can be connected with other pipes to form a pipeline.

Mandrel 508 takes the form of an internally positioned cylindrical, hollow mandrel, with an inner diameter along axis x. Mandrel 508 includes teeth 546 extending radially outwardly from the mandrel outer diameter surface, which is sometimes referred to as the outer surface. Mandrel 508 may also have tapered ends 508a where the thickness of the mandrel tapers toward each of the annular ends of the mandrel. The tapering is on the outer surface, while the inner diameter may remain substantially consistent along the full length of the mandrel. Tapered ends 508a define frustoconical surfaces on the outer surface of the mandrel.

Mandrel 508 has a length to span between the ends of the pipes and fits within the pipe ends. Thus, the ends of the pipes are each sized to accommodate mandrel 508, the inner diameter of the ends being slightly larger than the major or largest outer diameter across mandrel 508 at its teeth. To avoid a constriction in the inner diameter of the pipe, the inner diameter of mandrel 508 is about the same or larger than the normal inner diameter IDn of metal pipes and pipes 502a, 502b may be expanded at their ends to accommodate the mandrel therewithin. For example, as shown, each metal pipe has an upset, bell end 544 where the inner diameter IDe of the pipe is enlarged over the normal inner diameter IDn. Bell end 544 can be formed by plastic deformation or otherwise expanding the pipe at its end. For example, metal pipe 502 could be expanded at the factory using a hot or cold deformation process with a swage. The pipe may subsequently be heat treated to stress relieve the metal.

This formation of a bell end 544 creates a frustoconical shoulder 544a in the pipe wall between the pipe length with the normal inner diameter IDn and bell end 544. Frustoconical shoulder 546 is the length of the pipe where the inner diameter IDe of the pipe is increases in diameter from the normal inner diameter IDn.

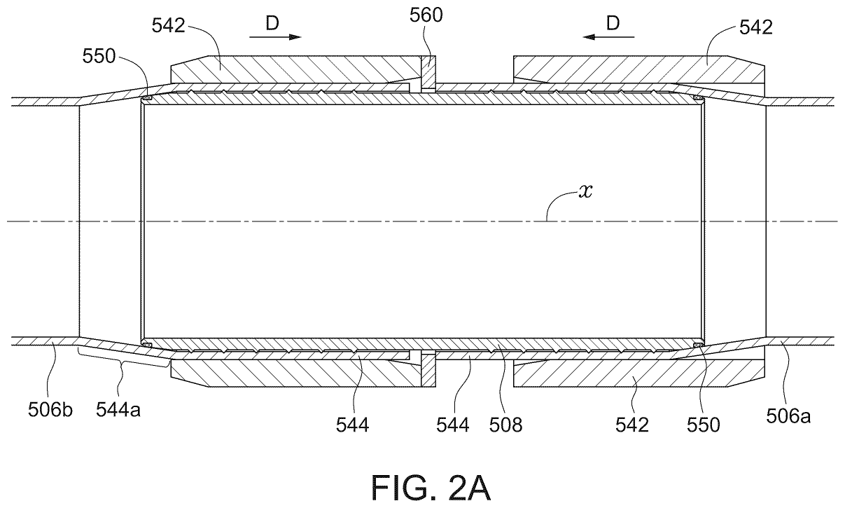

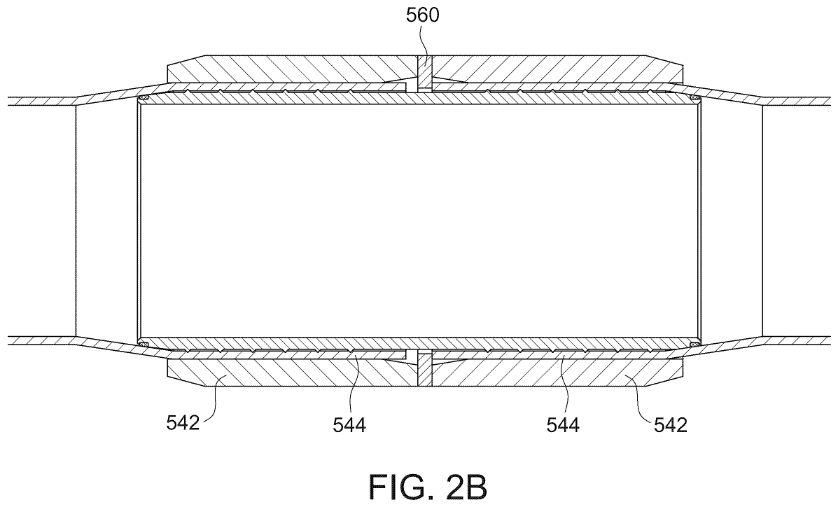

With additional reference to FIGS. 2A and 2B, to assemble the pipe connection, the mandrel is inserted into the bell ends of the metal pipe. The outer diameter of the mandrel at teeth 546 may be slightly less than the inner diameter IDe of the belled ends so that the mandrel can be inserted without much force, for example by hand.

As each pipe 506a, 506b is pushed over the mandrel, abutment of the end of mandrel 508 against frustoconical shoulder 544a ensures that the pipes are properly advanced over the mandrel. Each tapered end 508a resides radially inwardly of frustoconical shoulder 544a on each pipe.

Pipes 506a, 506b are driven into engagement with teeth 546 by press rings 542. Press rings 542 may be positioned over the end of each pipe prior to expansion and forming of the bell ends 544. The press rings 542 remain loose on the pipe until the pipes are joined together. After the mandrel is inserted into the bell ends, the loose press rings 542 are urged, arrows D, toward the bell ends 544 and pressed over the bell ends of the metal pipes. This attaches each of the metal pipes to the outer surface of the mandrel 508.

The inside diameter of each press ring 542 is smaller than the outside diameter of the bell section of the metal pipe over which it is to act. A taper 542a on the inside leading edge of the press ring compresses the metal pipe radially inward.

Teeth 546 on the outer surface of mandrel 508, penetrate and embed into the inner surface of the metal pipe. As noted above, the press ring can remain in place on the assembly to stiffen and strengthen the attachment by retaining the contact pressure between the metal pipe and the mandrel. The mandrel teeth profile, pitch, body wall thickness and material properties may be selected to ensure that the mandrel has sufficient strength to transfer the axial forces and contain the hoop forces. The mandrel is also selected with sufficient hoop stiffness and strength to allow the teeth to penetrate and embed into the inner surface of the metal pipes.

### Corrosion Mitigation

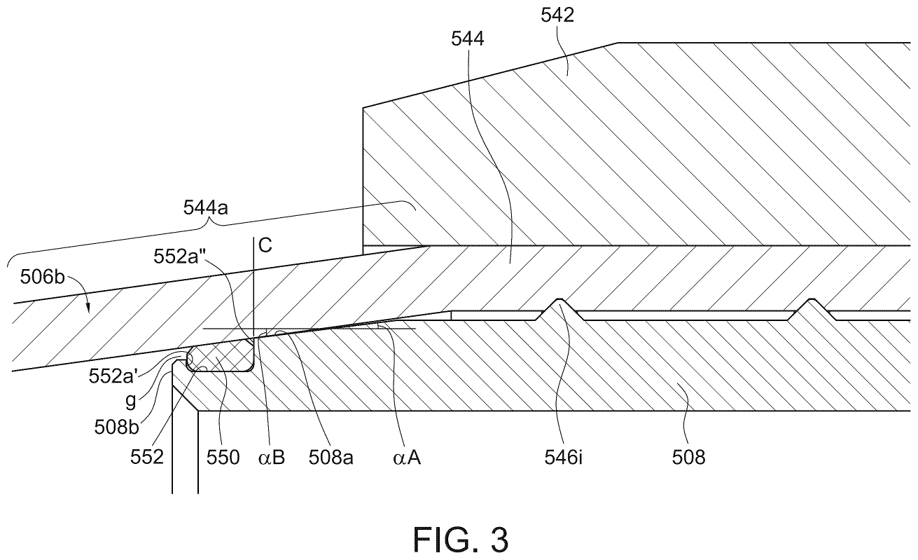

The accumulation and retention of fluid between the pipe inner wall and the mandrel, can generate corrosion therebetween. To prevent the accumulation of fluid, and therefore to mitigate corrosion between the pipe inner wall and the mandrel, an elastomeric seal may be provided at each end of the mandrel to seal between the mandrel and the inner surfaces of each of the pipes. For example, with additional reference to FIG. 3, an o-ring 550 may be provided in an o-ring gland 552 at each end of the mandrel. There is an o-ring 550 and o-ring gland 552 encircling the full circumference of the mandrel at each of its ends. The o-ring gland can be positioned on the tapering end 508a adjacent to the end, annular face 508b.

During assembly, the o-ring lands between the gland/the mandrel and the frustoconical shoulder 544a to create a seal therebetween.

In one embodiment, gland 552 is formed with side walls 552a′, 552a″ that extend generally orthogonally relative to axis x. As such, since gland 552 is cut into the tapering end 508a, the side wall 552a′ that is closest to the end of the mandrel has a height from the floor of the gland that is less than the height of side wall 552a″. In one embodiment, to permit flushing and drainage of fluid from the space between the gland and the end face, the thickness of mandrel between the end face and the side wall 552a′ is thinned to create a gap g. In other words, the degree to which surface 508a tapers is not consistent across the gland and the outer surface area between the gland and the end face either has a greater degree of taper than surface 508a, a greater degree of taper than that of frustoconical shoulder 554a or is otherwise cut back to be spaced away from shoulder 554a when assembled.

In one embodiment, to facilitate sealing of o-ring 550, and also to facilitate seating and concentric orientation of the mandrel within the pipe ends, the mandrel is selected to sit tightly against the frustoconical shoulder 544a at circumferential surface c, which is the top of wall 552a″, where wall 552a″ and the surface of tapered end 508a meet. In one embodiment, the outer diameter of mandrel at the intersection of wall 552a′ and the surface of tapered end 508a is selected to be the same as the outer diameter at a location along shoulder 544a. The tight fit between mandrel 508 and shoulder 544a at circumferential surface c ensures that there is little to no gap into which o-ring can extrude.

In one such embodiment, the degree of taper on surface 508a is less than the degree to which frustoconical shoulder 544a tapers, to ensure that mandrel bears against shoulder 544a at the top of wall 552a″. For example, tapering angle αA is less than tapering angle αB. In one embodiment, tapering angle αA is between 0.5 to 5 degrees less than tapering angle αB.

### Facilitated Assembly

As noted, the above configuration to preferentially have mandrel 508 bear against shoulder 544a at circumferential surface c, which is the top of wall 552a″, also facilitates seating and concentric orientation of the mandrel within the pipe ends. The size and position of the first annular tooth 546i (FIG. 3) can also be selected so that the combination of circumferential surface c and tooth 546i ensures a centered and aligned fit between the mandrel and the pipe end.

The first tooth may be positioned to ensure that surface c contacts the pipe before the first tooth contacts the pipe. This ensures that the contact point c is loaded up (seated) into the pipe bore before the first tooth is engaged. Once the first tooth is engaged there will be no further pre-load at point c because the first tooth will restrain the axial load. Therefore, the position of the first tooth controls the pre-load of point c. It is also advantageous for the first tooth to contact the pipe early in the process of pressing the ring as it stabilizes alignment. Contact at c and the contact at the first tooth, act together to align the mandrel 508 and pipe 544 to axis x.

In addition or alternatively, assembly may be improved by use of a stop ring 560. Stop ring 560 may be employed to ensure that the press rings 542 are not over advanced when making up the connection. If a press ring advances (FIG. 2A, arrows D) too far beyond the end of its pipe, the other press ring may not be able to be pressed on to its full pressed position, causing its pipe connection to be incomplete. To address this problem, stop ring 560 is a separate structure used in the connection assembly. Stop ring 560 is positioned to encircle the mandrel and between the bell ends of the two pipes. The stop ring protrudes radially outwardly beyond the thicknesses of the bell ends such that when the press rings are advanced (arrows D), the press rings butt against the stop ring if they advance too far beyond the end of its pipe.

Stop ring 560 is a ring that has an inner diameter (i) greater than the outer diameter of mandrel and (ii) less than the outer diameter at bell end 544. Stop ring 560 has an outer diameter greater than the outer diameter at bell end 544. As such, when ring 560 becomes positioned between the bell ends encircling the mandrel, the stop ring cannot move axially along axis x past the bell ends. Ring 560 is stopped from moving due to abutment against the end of the bell end. Further, stop ring 560 protrudes out such that it stops the press rings 542 from moving past it. This is shown in FIG. 2A, where the left side press ring has been pushed on so far that it is stopped by stop ring 560. In particular, left side press ring 542 has butted against the stop ring 560 such that stop ring is moved to the right. But the stop ring 560 cannot move past the bell end of pipe 506a and, thus, stop ring 560 has stopped the pressing advancement of press ring 542. Therefore, stop ring 560 prevents the left side press ring from being over-pressed.

FIG. 2B is a sectional view along the pipe connection of FIG. 2A after the right hand side press ring is advanced. The right hand side press ring is advanced a suitable amount and, in fact, can be rapidly pressed over the bell end 544 up to the stop ring. Of course, as shown in FIG. 1A, the stop ring need not be pushed to one side if the press rings are pressed on without acting against the force ring. In an embodiment employing a press ring, the method of assembly can be carried out more rapidly and in less controlled environments. For example, while the method could be carried out in a factory or other controlled setting, the assembly method including the installation of both pipes on the mandrel can be conducted in the field. Also, the pipe end and press rings can be installed quickly, as the stop ring structurally prevents over advancement of the press rings.

### Stronger Pipe to Mandrel Connections

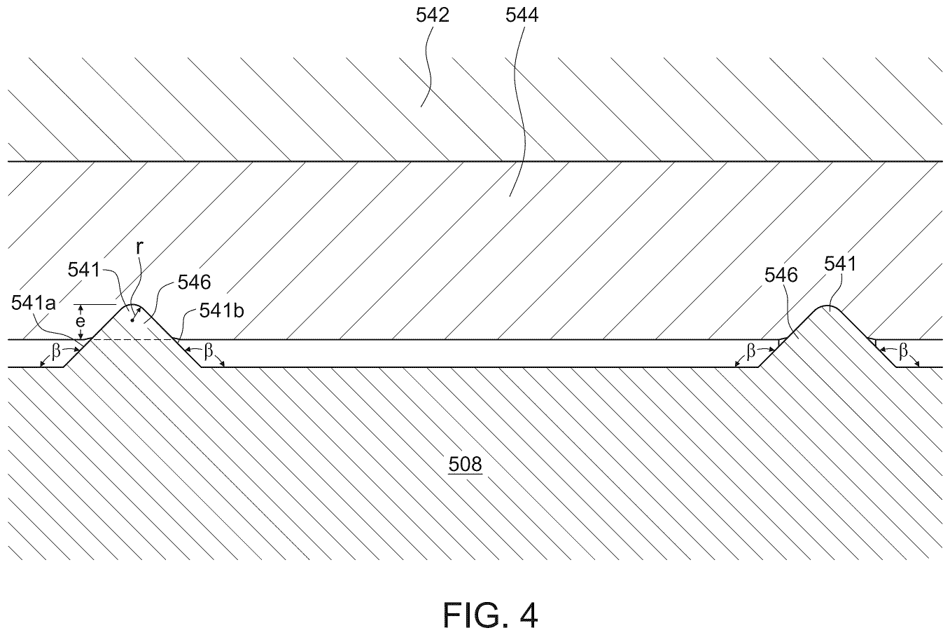

Teeth 546 have a profile which is the cross sectional shape therethrough. While various configurations for teeth 546 were disclosed in applicant's prior patents, continued research has determined that certain teeth configurations result in a stronger pipe to mandrel connection, as shown in FIG. 4.

Each tooth has a geometry including a tooth angle, a shape and a tip shaping. Tooth angle is the angle at which the first side flank 541a and the second side flank 541b meet at the tip 541. In one embodiment, the tooth angle is about 90 to 100° such as approximately 90 to 95°.

The illustrated teeth are also symmetrically formed wherein the first side flank 541a and the second side flank 541b angle away from the tip 541 toward the valleys between the teeth at approximately the same angle. For example, in the illustrated embodiment the first side flank 541a and the second side flank 541a are each substantially about +/−30 to 60° from an orthogonal reference extending radially from the long axis x of the mandrel. Stated another way, each of the tooth faces may extend at angle 3 of 120 to 150° from the long axis of the mandrel 508 on which the tooth is formed.

The illustrated teeth 546 from FIG. 4 also have a single, radiused tip 541. A radiused tip has been found to provide greater embedment depth e and, therefore, strength against pull force than either a blunt tooth or a sharp tooth.

The embedment depth is critical to achieving the required strength for the joint strength. The shear plane through the tooth (FIG. 4) should be as large as possible to improve strength. The shear plane size is dependent on the tooth geometry (tooth angle) and embedment depth.

The embedment depth is constrained by:
the amount of press force that can be transferred to the tooth embedment through the installation of the press ring without galling the surfaces between the press ring 542 and the pipe 544 or without exceeding practical limitations of machinery size and horsepower.
stress concentrations and localized hardening of materials at the tooth tip that can modify metallurgy to the point that it no longer complies with pipeline material regulations or adversely impacts the materials resistance to crack initiation and propagation. These limitations are extremely important to the safety of pipelines transporting H2S gas typically found in many oil and gas applications; and
relative hardness of the pipe and mandrel materials.

Design of the tooth tip 541 radius and tooth angle at the tip can facilitate achieving the desired embedment depth. If the radius on the tooth tip is too small, it can intensify the surface pressure during embedment resulting in excessive deformation, high stress concentrations or localized hardness. A larger radius on the tooth tip better distributes the surface pressure and will better transfer the loads into the tooth body. If the radius on the tooth tip is too large, the forces required to achieve the necessary tooth embedment can be unreasonably large. It has also been observed that a small radius can shear, cut into the pipe material, damaging the grain structure of the metal and weakening the joint strength. If the tooth angle is too small, the tooth will not have sufficient strength for the embedment loads and may deform excessively, not achieving the necessary embedment. This tooth geometry requires greater embedment to achieve the necessary shear plane to provide the required pipe joint strength. If the tooth angle is too large, the forces required to achieve the necessary tooth embedment will be too large.

Therefore, by radiusing the tips of the teeth, the stress concentrations in the pipe wall and the mandrel are reduced, which improves joint strength while maintaining material hardness. This is beneficial in various embodiments and especially where fluids being conveyed include a concentration of hydrogen sulfide. The radiusing of the tips also improves grain structure in the pipe wall and avoids shear of grains.

In one embodiment, for a tooth of height 1 mm to 2 mm with a tooth angle of 90 degrees, the radius r of tip 541 should be 0.6 mm to 0.35 mm. Testing has demonstrated that tooth radius in this range will perform better than a tooth radius of 0.5 mm. Stress analysis has shown that the tooth angle should be 90 to 100 degrees.

Once the embedment depth and tooth strength have been selected, the number of teeth will be selected to achieve the desired joint strength.

The mandrel includes a plurality of teeth spaced axially apart by a pitch, as shown. The number of teeth in a joint is constrained by the spacing of the teeth and the number of teeth that can be fit into a practical fitting length. The spacing of the teeth is constrained by the amount of force that can be transferred to the tooth embedment through the installation of the press ring. If the spacing is too low the forces required to press the ring over the pipe exceeds constraint (described above as galling and practical limitations of machinery size and horsepower).

While the tooth geometry and radius could be designed to achieve an acceptable tooth embedment for a pipe material with a slightly harder or higher strength than the mandrel and press ring, in one embodiment the tooth material, and likely the material of the entire mandrel, has a yield strength or hardness equal to or greater than the material to be engaged.

Teeth 546 are continuous in a circumferential direction around the mandrel and their embedment in pipe wall at bell end 544 can provide a pressure-tight seal.

The previous description of the disclosed embodiments is provided to enable any person skilled in the art to make or use the present invention. Various modifications to those embodiments will be readily apparent to those skilled in the art, and the generic principles defined herein may be applied to other embodiments without departing from the spirit or scope of the invention. Thus, the present invention is not intended to be limited to the embodiments shown herein, but is to be accorded the full scope consistent with the claims, wherein reference to an element in the singular, such as by use of the article “a” or “an” is not intended to mean “one and only one” unless specifically so stated, but rather “one or more”. All structural and functional equivalents to the elements of the various embodiments described throughout the disclosure that are known or later come to be known to those of ordinary skill in the art are intended to be encompassed by the elements of the claims. Moreover, nothing disclosed herein is intended to be dedicated to the public regardless of whether such disclosure is explicitly recited in the claims. No claim element is to be construed under the provisions of 35 USC 112, sixth paragraph, unless the element is expressly recited using the phrase “means for” or “step for”.

1. A pipe connection assembly comprising:
a first pipe section and a second pipe section, each of the first pipe section and the second pipe section including:
a metal tube having a length, an inner surface defining an inner diameter, an outer surface with an outer diameter, a wall thickness defined by the distance between the inner surface and the outer surface and a belled end with a larger inner diameter than the inner diameter through an adjacent portion of the metal tube and a larger outer diameter than the outer diameter;
a pipe mandrel for mechanically engaging the first pipe section to the second pipe section, the pipe mandrel formed as a cylindrical tube and including a first tubular end configured to mechanically engage the first pipe section and a second tubular end configured to mechanically engage the second pipe section, the pipe mandrel being sized to be positionable within the belled ends of the first pipe section and the second pipe section, the pipe mandrel including teeth radially outwardly extending therefrom and having an inside diameter substantially equal to or greater than the inner diameter;
a press ring having an inside diameter smaller than the outer diameter of the metal tube and the press ring configured to be installed encircling the belled end radially outwardly of the pipe mandrel and to deform and hold the belled end radially inwardly into engagement with the teeth; and
an elastomeric seal in an annular gland at an end of the mandrel.

2. The pipe connection assembly of claim 1 wherein the teeth each have a radiused tip.

3. The pipe connection assembly of claim 1 wherein the belled end includes tapered area that has a tapering angle between the inner diameter and the larger inner diameter of the belled end and the pipe mandrel includes a tapering surface at the end and wherein the angle at which the tapering surface tapers is less than the tapering angle of the belled end.

4. A pipe connection assembly comprising:
a first pipe section and a second pipe section, each of the first pipe section and the second pipe section including:
a metal tube having a length, an inner surface defining an inner diameter, an outer surface with an outer diameter, a wall thickness defined by the distance between the inner surface and the outer surface and a belled end with a larger inner diameter than the inner diameter through an adjacent portion of the metal tube and a larger outer diameter than the outer diameter;
a pipe mandrel for mechanically engaging the first pipe section to the second pipe section, the pipe mandrel formed as a cylindrical tube and including a first tubular end configured to mechanically engage the first pipe section and a second tubular end configured to mechanically engage the second pipe section, the pipe mandrel being sized to be positionable within the belled ends of the first pipe section and the second pipe section, the pipe mandrel including teeth radially outwardly extending therefrom and having an inside diameter substantially equal to or greater than the inner diameter;
a press ring having an inside diameter smaller than the outer diameter of the metal tube and the press ring configured to be installed encircling the belled end radially outwardly of the pipe mandrel and to deform and hold the belled end radially inwardly into engagement with the teeth; and
a stop ring encircling the mandrel and positioned between the belled ends.

5. The pipe connection assembly of claim 4 wherein the teeth each have a radiused tip.

6. The pipe connection assembly of claim 4 wherein the stop ring has an inner diameter (i) greater than the outer diameter of mandrel and (ii) less than the outer diameter across the bell end and the stop ring has an outer diameter greater than the outer diameter at the bell end.

7. A method for joining a first pipe section to a second pipe section, each of the first pipe section and the second pipe section including:
a metal tube having a length, an inner surface defining an inner diameter, an outer surface with an outer diameter, a wall thickness defined by the distance between the inner surface and the outer surface and a belled end with a larger inner diameter than the inner diameter through an adjacent portion of the metal tube and a larger outer diameter than the outer diameter;
the method comprising:
inserting a pipe mandrel into the belled end of the first pipe section and into the belled end of the second pipe section;
installing a press ring to encircle the belled end of the first pipe section, the press ring having an inner diameter smaller than a diameter across the outer surface of the belled end and installing the press ring includes deforming the metal tubular wall of the first pipe section radially inwardly into mechanical engagement with teeth on an outer diameter of the pipe mandrel; and
leaving the press ring in place encircling the wall of the first pipe section to hold the wall in mechanical engagement with the pipe mandrel, wherein the method further comprises one or more of:
a) inserting the pipe mandrel includes urging an annular elastomeric seal on an end of the pipe mandrel into sealing engagement against the inner diameter of the belled end; and
b) positioning a stop ring around the pipe mandrel prior to inserting such that the stop ring resides between the belled ends and stopping advancement of the press ring during installing by abutting against the stop ring.

8. The method of claim 7 wherein the pipe mandrel includes further outwardly extending teeth on the outer diameter and mechanically engaging the second pipe section to the pipe mandrel includes deforming the second metal tube into engagement with the further outwardly extending teeth and installing a second press ring to encircle the second metal tube and to hold the second metal tube in engagement with the further outwardly extending teeth.

9. A pipe connection comprising:
a first pipe having a length, an inner surface defining an inner diameter, an outer surface with an outer diameter, and a wall thickness defined by the distance between the inner surface and the outer surface;
a second pipe having a cylindrical wall with a cylindrical outer surface and a cylindrical inner bore;
a pipe mandrel mechanically engaging the first pipe to the second pipe, the pipe mandrel formed as a cylindrical tube with outwardly extending teeth and including a first tubular end mechanically engaged within the inner diameter and a second tubular end mechanically engaged within the cylindrical inner bore;
a first press ring having an inside diameter smaller than the outer diameter of the first pipe, the press ring encircling the first pipe radially outwardly of the pipe mandrel and deforming the first pipe radially inwardly into engagement with the teeth on the first tubular end;
a second press ring having a diameter smaller than the cylindrical outer surface of the second pipe, the second press ring encircling the second pipe radially outwardly of the pipe mandrel and deforming the second pipe radially inwardly into engagement with the teeth on the second tubular end; and
at least one of:
a) an elastomeric seal in an annular gland at each end of the mandrel; and
b) a stop ring encircling the mandrel and positioned between the belled ends.

10. The pipe connection of claim 9 wherein the teeth each have a radiused tip.

11. The pipe connection of claim 9 wherein each belled end includes a tapered area that has a tapering angle between the inner diameter and the larger inner diameter of the belled end and the pipe mandrel includes a tapering surface at each end and wherein the angle at which the tapering surface tapers is less than the tapering angle of the belled end.
